(19) United States
(12) Patent Application Publication
(10) Pub. No.: US 2007/0077194 A1
(43) Pub. Date: Apr. 5, 2007

(54) Enhanced energy production system

(76) Inventors: Allan Mitchell, Broadbeach Waters, Queensland (AU); Geoffrey David Will, Queensland (AU)

Correspondence Address: HOFFMAN WASSON & GITLER, P.C;CRYSTAL CENTER 2, SUITE 522, 2461 SOUTH CLARK STREET, ARLINGTON, VA, 22202-3843, US

(21) Appl. No.: 10/568,342

(22) PCT Filed: Aug. 12, 2004
(86) PCT No.: PCT/AU04/01080

§ 371 Date: Jun. 5, 2006

(30) Foreign Application Priority Data
Aug. 15, 2003 (AU) 2003904338

(51) Int. Cl. C01B 3/02

(52) U.S. Cl. 423/648.1

(57) ABSTRACT

An enhanced energy production system having the step of introducing steam at elevated temperature and a positive pressure into an enhanced reactor, wherein a portion of the energy added to the reactor system by the addition of the steam is used by reaction systems in the reactor to increase the number of dissociated H₂O molecules at or near a reactive or catalytic surface

### FIELD OF THE INVENTION

The present invention relates to energy production and in particular to a system for increasing the yield of an existing energy production system which provides a non-polluting source of energy from water in the form of hydrogen and heat.

### BACKGROUND ART

A variety of energy sources are presently available, such as nuclear, solar, hydroelectric, geothermal, wind and tidal power. However, by far the most common and convenient sources of energy at present are those based on the combustion of carbonaceous products. For example, coal, gas, coke, wood, petroleum and diesel. By necessity, when such carbonaceous products burn they produce oxides of carbon, most notably CO₂.

CO₂ has become notorious as a “greenhouse” gas and the 1997 Kyoto protocol aims to reduce the level of such greenhouse gases and ultimately minimize the extent of global warming and its consequences.

The use of Hydrogen as a fuel therefore represents an attractive alternative.

Fuel cells convert hydrogen directly into electrical energy by reactions which involve the reforming of hydrogen rich organic compounds (such as methane and methanol) by means of steam, catalysis, elevated temperatures and the like. Fuel cells operate by the direct conversion of chemical energy in a fuel to electrical energy without an intermediate combustion change. They represent the principal next generation source of mass energy production and are poised to make a significant contribution to power generation. However, these fuel cells suffer from the disadvantage that they all produce oxides of carbon, such as CO or CO₂, when using reformed organics as their hydrogen source.

On the earth, free or uncombined hydrogen is rare. It is commonly found in a combined form such as water, hydrocarbons and all plant and animal matter. In producing elemental hydrogen, the primary considerations are usually cost and convenience. In the laboratory, pure hydrogen is usually made by the reaction of a suitable metal with a displacement acid or by the electrolysis of water. For commercial hydrogen, the primary sources are water and hydrocarbons. These endothermic processes require energy.

Molecular hydrogen is an important source of energy, as evidenced by the endothermic nature of its production. Its internal energy can be released either by combustion or by reaction with oxygen in a fuel cell.

However, the combustion of hydrogen gas directly produces no oxides of carbon-clean combustion produces theoretically only pure water.

The electronic and dehydrogenation process mentioned above for the production of molecular hydrogen produce by-products which may be unwanted. Electrolysis produces oxygen, which is useful, but dehydrogenation of organic compounds produces carbon dioxide, a global warming gas. These processes also require considerable energy input from external sources.

Attempts have been made to produce pure molecular hydrogen by self sustaining exothermic reactions. Conventional hydrogen generators are described in U.S. Pat. No. 4,463,063 and refer to the reaction of metal hydrides with water and the use of extruded electropositive metal anodes which gradually dissolve in the electrolytes, to provide electrons for discharge at inert cathodes.

In all of these instances the resulting compounds apart from the hydrogen produced, are regarded as waste, with problems associated with their collection and disposal.

Pure hydrogen can be liberated from water according to the following half cell equation:
2H₂O+2e⁻→2OH−+H₂ E^{o}=−0.828V.

In theory, any electropositive system with an Eₒ value greater than 0.828 V can react with water to produce hydrogen. Examples of such electropositive systems with Eₒ values above 0.828 V include hydrides, for example:
2H−→H₂+2e⁻E^{o}=2.23V

Although reactions of metals to produce hydrogen such as that given by:
Al+H₂O+NaOH→NaAlO₂+1½H₂
are chemically feasible, they are kinetically very slow and the hydrogen is produced at a slow rate over a long period. This “trickle” of hydrogen is unsatisfactory for commercial use.

It is desirable therefore to maximize not only the amount of hydrogen produced by a cell, but also the rate of hydrogen production.

More recent inventions in the field disclose generators for the production of hydrogen from methanol (U.S. Pat. Nos. 5,712,052 and 5,885,727). However, a by-product of the said reaction is carbon monoxide which is adsorbed by the catalyst, causing “catalyst poisoning”, which refers to the deterioration of the catalytic function of the electrode, and subsequent lowering in the energy efficiency of the system. In order to minimize this problem, such generators must necessarily be equipped with means for measuring the carbon monoxide concentration in the system as well as means for decreasing it.

The commercially useable hydrogen being produced as late as August 2004 was being extracted mostly from natural gas. Nearly 90% of hydrogen is obtained by steam reformation of naptha or natural gas. Gasification of coal and electrolysis of water are the other industrial methods for hydrogen production. However, these processes are highly energy-intensive and not always environmentally friendly due mainly to the production of either CO₂ or CO as a product.

The steam-iron process is one of the oldest ways of producing hydrogen.
iron+steam [symbol] iron(III) oxide+hydrogen.
2Fe₍ₛ₎+3H₂O_{(g)} [symbol] Fe₂O₃₍ₛ₎+3H_{2(g)}
Note that the reaction between iron and steam is reversible.

Although it was considered to be an important option, also from the economic point of view for producing hydrogen with a high purity, the steam reforming of natural gas or partial oxidation of heavy oils outweighed it. The interest in the steam-iron process has recently grown due to the relatively clean hydrogen that can be produced in this process, which is especially important for the use of hydrogen in fuel cells and also due to the possibility to use renewable energy sources for this process.

One prior art system utilising the steam-iron process is directed to a repetitive cycle process in which the relevant reaction pathways are:
3Fe₍ₛ₎+4H₂O_{(g)} [symbol] Fe₃O₄₍ₛ₎+4H_{2(g)}
3FeO+H₂O_{(g)} [symbol] Fe₃O₄₍ₛ₎+H_{2(g)}

Natural gas or other gaseous reducing species can remove oxygen from the higher oxidation state such as Fe₂O₃ (hematite) or Fe₃O₄ (magnetite) forming a stream of carbon oxides, water and unconverted hydrocarbons. If operating conditions and the reactor design are appropriately selected, only carbon dioxide and water are produced as per the following equations:
4Fe₂O₃+CH₄ [symbol] 8FeO+CO₂+2H₂O
4Fe₂O₃+3CH₄ [symbol] 8Fe+3CO₂+6H₂O
4Fe₃O₄+CH₄ [symbol] 12FeO+CO₂+2H₂O
Fe₃O₄+CH₄ [symbol] 3Fe+CO₂+2H₂O
Condensing water leaves a pure carbon dioxide stream ready to be stored. The disadvantages with this system are that different reactor and Fe regeneration vessels must be used to maximize the purity of the hydrogen removed and that carbon dioxide is still produced.

Our previous system was a method for generating hydrogen and/or energy from a chemical reaction including the steps of: selecting an electronegative half cell reaction producing hydrogen; selecting an electropositive half cell reaction having a sufficient potential to drive said electronegative half cell reaction; selecting a second electropositive half cell reaction; said first and second electropositive half cell reactions selected in combination with said electronegative half cell reaction to produce an increase in hydrogen and/or energy production from water; and combining said half cell reactions. This system, through a suitable selection of half-cell reactions, chemical concentrations, and inherent interactions produced approximately 67 liters of hydrogen at STP from 54 g of reactant and 1 liter of water. As a by-product, the system produced a high amount of steam.

The transport and storage of energy and fuel are also often problematic. The direct transference of electricity results in substantial losses of energy when the electricity is transmitted over long distances. Large infrastructure investments are also required for electricity transmittal over long distances which require the use of high tension wires and towers and booster and substation arrays to ensure delivery of adequate power to the consumer.

The transmission of gaseous fuels, such as natural gas, also requires substantial infrastructure to ensure adequate pressure and supply to consumers. Single use and rechargeable cylinders are practicable in some cases but even household size cylinders are bulky and heavy and require regular replacement.

It will be clearly understood that, if a prior art publication is referred to herein, this reference does not constitute an admission that the publication forms part of the common general knowledge in the art in Australia or in any other country.

### SUMMARY OF THE INVENTION

The present invention is directed to an enhanced energy production system, which may at least partially overcome at least one of the abovementioned disadvantages or provide the consumer with a useful or commercial choice.

In one form, the invention resides in an enhanced energy production system having the step of introducing steam at elevated temperature and a positive pressure into an enhanced reactor, wherein a portion of the energy added to the reactor system by the addition of the steam is used by reaction systems in the reactor to increase the number of dissociated H₂O molecules at or near a reactive or catalytic point in the reactor.

The energy generator produces pure gaseous hydrogen by the reduction of water by electro positive half-cell reactions involving two or more electropositive redox systems. The systems are chosen to maximise hydrogen production and desirably to produce by-products which are valuable rather than harmful or useless.

The invention may use the steam produced as a by-product of a method for generating hydrogen and/or energy from a chemical reaction including the steps of: selecting an electronegative half cell reaction producing hydrogen; selecting a first electropositive half cell reaction having a sufficient potential to drive said electronegative half cell reaction; selecting a second electropositive half cell reaction; said first and second electropositive half cell reactions selected in combination with said electronegative half cell reaction to produce an increase in hydrogen and/or energy production from water; and combining said half cell reactions. However, steam from any source may be used.

In another form, the invention resides in an enhanced energy production system having the step of introducing steam at elevated temperature and a positive pressure into an enhanced reactor, affecting molecular oscillations of H₂O molecules using an energy source wherein a portion of the energy added to the reactor system by the energy source is used by reaction systems in the reactor to increase the number of dissociated H₂O molecules at or near a reactive or catalytic point in the reactor.

Typically the reactive or catalytic point in the reactor may be a reactive or catalytic surface or portion thereof.

The energy source used to affect the molecular oscillations may be any source, but preferred sources a renewable energy sources such as solar energy or microwave energy sources. These energy sources may be used in addition to or alternatively to using the steam entering the enhanced reactor as an energy source.

The enhanced reactor of the present invention may also include a reaction system. The reaction system may include one or more half cell reactions. The half cell reactions may be the same as, similar to or entirely different from the reactions discussed above with reference to the method for generating hydrogen which produced steam as a by-product. Combinations of electronegative half cell reactions and electropositive half cell reactions may be used. The reaction system or half cell reactions may require or be assisted by the provision of a reactive or catalytic surface. For example, the surface may provide an alternative reaction pathway with lower activation energy. As the surface may allow the reaction to occur at a lower activation energy, a larger fraction of collisions or interactions may occur and be effective at a given temperature or pressure. This may increase the reaction rate. Preferably, the enhanced reactor may affect the rate determining step of the reaction system. The reaction kinetics of the reaction system in the enhanced reactor may be affected. The enhanced reactor may preferably affect either the rate constant or the order of the reaction system resent in the enhanced reactor.

It may also be that by the addition of steam at elevated temperatures and positive pressures, the environment within the enhanced reactor may be made more conducive to the production of hydrogen. The increased temperature caused by the steam may increase the rate of at least some of the reactions in the system within the reactor.

In certain preferred embodiments of the present invention, it may be possible to select the half cell reactions such that the sum of the value of residual materials in the hydrogen cell at the endpoint of the reaction is greater than that of the sum of reactants introduced into the cell.

Preferably, the reaction system is an inorganic chemical system.

Preferably, the second electropositive half cell reaction can also drive the electronegative half cell reaction.

The chemical system may include additional electropositive half cell reactions.

Preferably, one of the electronegative half cell reactions is:
2H₂O+2e⁻→2OH³¹ +H₂.

Preferably, one of the electropositive half cell reactions is:
Mg→Mg²⁺+2e⁻.

Preferably, one of the electropositive half cell reactions is:
Al+4OH→AlO₃₋+2H₂O+3e⁻.

Preferably, the electropositive half cell reactions involve the oxidation of species selected from Group I or Group II metals, binary hydrides, ternary hydrides, amphoteric elements, electropositive elements in groups one and two of the periodic table and chelated transition elements, oxyacids of phosphorus and oxyacids of sulfur.

In general, the reductant can be any system having an Eₒ value greater than +0.83 V when a reductant is written on the left hand side of the half-cell equation is according to the Latimer convention.

In highly preferred combinations, the half cell reductant is a binary and/or ternary hydride, in combination with an amphoteric element. Amphoteric elements preferred include aluminium, zinc, chromium, gallium and tin. Aluminium is particularly preferred. Iron may also be used.

Preferably, the reductant in the first electropositive half cell is hypophosphorous acid or dithionite.

The reductant in the first electropositive half cell reaction may also be a metal organic complex capable of changing configuration to release one or more electrons in a realisation of an increased co-ordination number.

As stated above, the reaction system or half cell reactions in the enhanced reactor may require or be assisted by the provision of a reactive or catalytic surface. The reactive or catalytic surface may be or include a half-cell reductant. The reductant may be capable of partial or total regeneration.

In a most preferably embodiment, the reductant may form a further reactive or catalytic reagent, allowing or facilitating further reactions to take place. Suitably, the reductant may form a semiconductive material or molecule. Most preferably, a semiconductor crystal may be formed. Such a crystal may be a highly ordered structure known as a lattice. Such a lattice structure may yield a periodic potential throughout the material. There may be more than one semiconductor material species present in the enhanced reactor.

The reduction of the reductant to form the semiconductive material may preferably enhance the hydrogen production as the semiconductive material may catalyse further reactions in the enhanced reactor. Suitably, further exothermic reactions are catalysed. The semiconductor material may be or be produced from a metal. One or more metals may also be present in the enhanced reactor.

The reactor may also experience one or more localised heating effects. These effects may arise as the temperature at the point of a reaction, that is microscopically, is typically much higher than the actual temperature of the solution when considered on a macroscopic level. Thus if a further reaction occurs at the point of reaction while the temperature is still very high, there may be an increase in the kinetics of the reaction due to the elevated temperature at the point.

The semiconductor material may possess energy bands consisting of a large number of closely spaced energy levels. The energy levels in a semiconductor are generally grouped in bands, separated by energy band gaps. The behaviour of electrons at the top and bottom of such a band is typically similar to that of a free electron. However, the electrons may be affected by the presence of the periodic potential of the semiconductor material.

The reactive properties of a semiconductor are usually dominated by the highest partially empty band and the lowest partially filled band. Consideration of these bands only leads to a simplified energy band diagram for semiconductors as illustrated in FIG. 1.

The almost full band may be called the valence band since it is occupied by valence electrons. The almost empty band can be termed the conduction band, as electrons may be free to move in this band and contribute to the conduction and reactivity of the material.

The simplified energy band diagram in FIG. 1 is used to describe semiconductors. Shown are the valence and conduction bands as indicated by the valence band edge, Eᵥ, and the conduction band edge, E_{c}. The vacuum level, E_{vacuum}, and the electron affinity, χ are also indicated in the figure.

FIG. 1 identifies the almost-empty conduction band by a horizontal line. This line indicates the bottom edge of the conduction band and is labelled E_{c}. Similarly, the top of the valence band is indicated by a horizontal line labelled Eᵥ. The energy band gap is located between the two lines, which are separated by the bandgap energy E_{g}. The distance between the conduction band edge, E_{c}, and the energy of a free electron outside the crystal (called the vacuum level labelled E_{vacuum}) is quantified by the electron affinity, χ multiplied with the electronic charge q.

The energy bandgap of semiconductors tends to decrease as the temperature is increased. This behaviour may be better understood if one considers that the interatomic spacing increases when the amplitude of the atomic vibrations increases due to the increased thermal energy. Therefore, using steam in the enhanced reactor with its corresponding increase in temperature, may activate the semiconductor by decreasing the bandgap.

In a semiconductor, the completely filled band is generally close enough to the next higher empty band that electrons can make it into the next higher band. In the almost empty band, electrons are free to move in this band and contribute to the conduction of the material, and also to the reactivity of the material.

By narrowing the energy bandgap using steam in the enhanced reactor with its corresponding increase in temperature, this may increase reactivity of the semiconductor by decreasing the bandgap and allowing the movement of electrons between the conduction band and the valence band. Partially filled bands do contain electrons as well as available energy levels at slightly higher energies.

The temperature dependence of the energy bandgap, E_{g}, has been experimentally determined yielding the following expression for E_{g} as a function of the temperature, T:

$${E}_{g} ( T ) = {E}_{g} ( 0 ) - \frac{α {T}^{2}}{T + β}$$

where E_{g}(0), α and β are the fitting parameters.

The surfaces and interfaces of semiconductors may therefore typically contain a large number of combination centers because of the abrupt termination of the semiconductor crystal, which leaves a large number of electrically active dangling bonds. In addition, the surfaces and interfaces are more likely to contain impurities since they are exposed during the device fabrication process which may further increase the reactivity of the material.

Preferably, the (water) molecule may be drawn down to the reactive or catalytic surface rapidly. The H₂O molecule may adopt a favourable orientation in the (001) plane with the oxygen atom pointing towards the surface.

According to a particularly preferred embodiment of the present invention in which a specific catalyst is used, when the oxygen atom is within approximately about 2.7 Angstrom of a bridging oxide iron on the reactive or catalytic surface, there may be a strong interaction between the hydrogen of the H₂O molecule and the bridging oxygen of the oxide ion. This hydrogen atom may then be captured by the bridging oxygen and the hydroxyl remnant of the H₂O molecule may adsorb above the fivefold “cation site”.

The enhancement process according to this preferred embodiment may enhance the number of dissociated H₂O molecules adsorbed onto the reactive or catalytic surface and then release the terminal OH groups as oxygen gas and the bridging OH groups as hydrogen gas. The terminal OH groups may therefore act as electron donors.
Viz OH⁻→½O₂+H⁺2e⁻E^{o}=−1.23V.
Whereas the bridging protonated oxide ions act as electron acceptors.
Viz 2e⁻+OH⁻+H⁺→O⁻+H₂ E^{o}=−0.00V.

Suitably, the discharge of the terminal OH group may produce oxygen gas plus a proton. This proton may then be attracted towards a negative OH bridging group where reduction produces hydrogen gas and an oxide ion, which remains in the crystal lattice.

The reactive or catalytic surface of the enhanced reactor may be capable of regeneration. For example, use of aluminium leads to the formation of Al₃H₂O which can in turn be converted into alumina and back to aluminium by cathodic reduction, producing a metal. Preferably, carbonaceous molecules are not used in the regeneration so as to minimize the production of carbon monoxide or carbon dioxide.

The reactive or catalytic surface may be provided as a cathode screen. The cathode screen may perform a catalytic function and is used to facilitate electron transfer in the system, and has the effect of increasing the rate of the reaction. The screen may accept electrons from the electropositive system and transfer these to the water to a greater rate than would be observed if the electron transfer was only occurring directly from the electropositive system to the water.

More preferably, the enhanced reactor is an alkaline cell which uses a mesh cathode to provide electrons for the reduction of water according to the half cell equation:
2H₂O+2e⁻→20H−+H₂ E^{o}=−0.41 V

said half cell electro-chemical equation being coupled with another half cell reductant for the production of hydrogen. Desirably, the inert mesh cathode consists of platinised titanium to assist anodic corrosion thereby aiding electron transfer from the reductant.

Suitably, the reactions taking place in the enhanced reactor may proceed at an increased rate due to the heat added by the steam. As the reactions taking place in the enhanced reactor suitably have a net exothermic value when considered together, more heat may be produced than is consumed by any endothermic reactions also taking place in the enhanced reactor. In turn, this net increase in heat may further increase the rate of the reactions in the enhanced reactor.

It is also preferred that the reactions are selected such that the sum of the value of residual materials in the hydrogen cell at the endpoint of the reaction is greater than that of the sum of reactants introduced into the cell.

The enhanced reactor of the present invention preferably includes an associated heat exchange system that can be used to transfer heat from an exothermic chemical reaction in the cell or control the rate of the exothermic chemical reaction(s). The heat exchange system may operate by condensing the steam produced by the direct heating of the water in the aqueous system by the reaction. The heat exchange system may be used for other purposes (eg, domestic heating) or simply as a way of controlling the rate of reaction in the generator. It is known that increasing temperature increases the rate of a reaction.

Larger centrally located units for producing and distributing greater volumes of hydrogen and heat may use a continuous input of chemicals, introduced in batch mixtures at regular intervals and from which solutions of the value-added products can be removed. The recirculated cooling water may be used to replenish the water used up in the production of hydrogen, thus keeping the reaction temperature high enough to ensure a continuing vigorous reaction.

According to a second aspect, the invention provides a two part process for generating hydrogen and/or energy, the first part being a primary reaction system including the sub-steps of selecting an electronegative half cell reaction producing hydrogen; selecting a first electropositive half cell reaction having a sufficient potential to drive said electronegative half cell reaction; selecting a second electropositive half cell reaction; said first and second electropositive half cell reactions selected in combination with said electronegative half cell reaction to produce an increase in hydrogen and/or energy production from water; and combining said half cell reactions; and the second part including the introduction of steam produced as a by-product of the first step at elevated temperature and a positive pressure into an enhanced reactor, wherein a portion of the energy added to the reactor system by the addition of the steam is used by reaction systems in the reactor to increase the number of dissociated H₂O ions at or near a reactive or catalytic surface.

According to a third aspect, the invention provides an enhanced reactor including: a reaction system which produces hydrogen from water; a supporting reactive of catalytic surface on which the hydrogen over-potential is low, thereby increasing the rate of reaction and subsequent rate of hydrogen generation relative to the rate of reaction in the absence of said reactive of catalytic surface.

The reactive of catalytic surface may be or include a cathode surface.

Preferably, the produced hydrogen is capable of forcing aqueous components of the cell out of contact with reactive solid components and into a holding reservoir, thereby resulting in a reduction in hydrogen and heat production.

The generator of the present invention preferably includes an associated heat exchange system that can be used to transfer heat from an exothermic chemical reaction in the cell or control the rate of the exothermic chemical reaction.

Preferably, either of the reactors (primary reaction system or enhanced reactor) of the present invention comprises a pressure vessel, the size of which will depend on the nature of the application. In the case of say, domestic use in villages, the unit is engineered of high quality reinforced polyester that is desirably portable and robust. A small domestic reactor may include a means for introducing reactants and a means for removing reactants and/or products as a batch process.

### BRIEF DESCRIPTION OF THE DRAWINGS

Various embodiments of the invention will be described with reference to the following drawings, in which:

FIG. 1 is a simplified energy band diagram used to describe semiconductors.

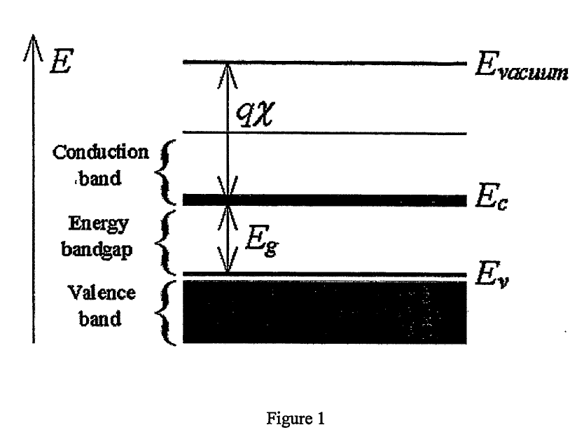

FIG. 2 is a schematic flow diagram illustrating a preferred embodiment of the present invention in which the steam produced in a primary reactor is used as a feedstock to an enhanced reactor.

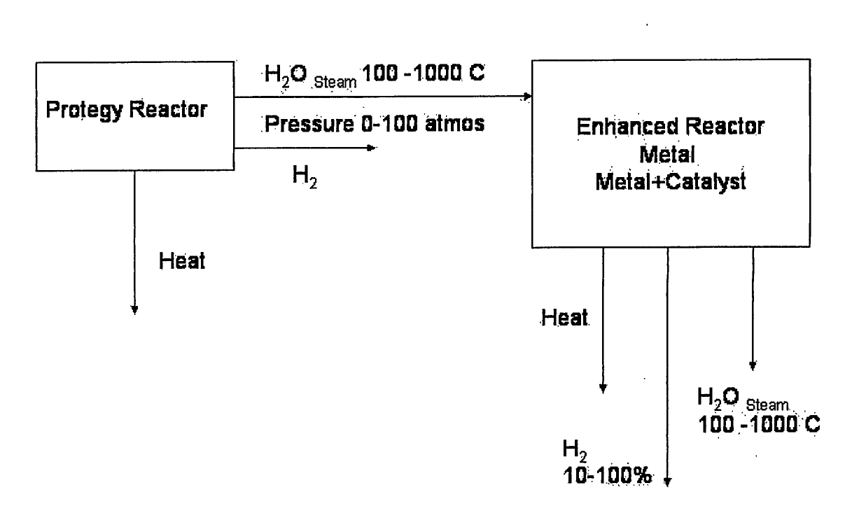

### DETAILED DESCRIPTION OF THE INVENTION

According to an aspect of the present invention, an enhanced energy production system is provided.

In a preferred embodiment, the cell for carrying out the present invention is an alkaline cell, which uses an inert mesh cathode to provide electrons for the reduction of water according to the half cell equation (equation 1) below:
2H₂O+2e⁻→2OH−+H₂ E^{o}=−0.41 V

This is a well-documented electrochemical reaction which theoretically can be coupled with another half cell reductant having an E^{o} value greater than −0.41 V in order to produce hydrogen. However, the kinetics of the processes sometimes makes such combinations impracticably slow.

The present invention describes exceptions to the above, which can be found in the use of binary and ternary hydrides, the amphoteric elements and electropositive elements in groups one and two of the Periodic Table. In some of these instances the mesh cathode does not provide galvanic interaction merely acts as a convenient reaction platform. The enhanced reactor of the present invention includes a selection of chemicals, which react with water, the reaction possibly facilitated or enhanced by a reactive or catalytic surface. The selection of chemicals have a low hydrogen overpotential, thereby increasing the rate of reaction and subsequent rate of hydrogen generation. The relevant half cell reactions are:
2H₂O→O₂+4H⁺4e− E^{o}=+0.828 V
2H₂O+2e−→H₂+2OH⁻ E^{o}=−0.41 V
Adding:
H₂O+→½O₂+H₂ E^{o}=−1.23 V
Generally, one or more further electropositive half cell reactions involving the oxidation of species selected from Group I or Group II metals, binary hydrides, ternary hydrides, amphoteric elements, electropositive elements in groups one and two of the periodic table and chelated transition elements, oxyacids of phosphorus and oxyacids of sulphur will also take place in the enhanced reactor.

In a highly preferred combinations, the half cell reductant is a binary and/or ternary hydride, in combination with an amphoteric element. Amphoteric elements preferred include aluminium, zinc, chromium, gallium and tin. Aluminium is particularly preferred. Iron can also be used.

The reductant in the first electropositive half cell reaction may also be a metal organic complex capable of changing configuration to release one or more electrons in a realisation of an increased co-ordination number.

As stated above, the reaction system or half cell reactions in the enhanced reactor may require or be assisted by the provision of a reactive or catalytic surface. The reactive or catalytic surface may be or include a half-cell reductant. The reductant may be capable of partial or total regeneration.

In a most preferably embodiment, a reductant forms a further reactive or catalytic reagent, allowing or facilitating further reactions to take place. Suitably, one or more reductants will form a semiconductive material or molecule.

The reduction of one or more reductants to form the semiconductive material may preferably enhance the hydrogen production as the semiconductive material can catalyse further reactions in the enhanced reactor. Suitably, further exothermic reactions are catalysed.

The reactions taking place in the enhanced reactor may proceed at an increased rate due to the heat added by the steam. As the reactions taking place in the enhanced reactor suitably have a net exothermic value when considered together, more heat may be produced than is consumed by any endothermic reactions also taking place in the enhanced reactor. In turn, this net increase in heat may further increase the rate of the reactions in the enhanced reactor.

The enhanced reactor of the present invention will generally include an associated heat exchange system that can be used to transfer heat from an exothermic chemical reaction in the cell or control the rate of the exothermic chemical reaction(s).

The enhanced reactor is configured such that the hydrogen produced can build up to a pressure such that it can force the aqueous components of the cell out of contact with the reactive solid components and into a holding reservoir. In this way, the enhanced reactor can be made self regulating-hydrogen is produced while the aqueous components are in contact with the reactive solids, but as the hydrogen is produced, the aqueous components are forced away from the solids by pressurized hydrogen, thereby resulting in a reduction in hydrogen production. When hydrogen is drawn off, the pressure is released, allowing the aqueous components to come back into contact with the solids and causing the reaction to recommence. The hydrogen can be removed either batchwise, as described above, or in a continuous fashion to regulate hydrogen production. The reactor size and configuration can be selected based on the amount of hydrogen production required.

The cathode screen performs a catalytic function and is used to facilitate electron transfer in the system, and has the effect of increasing the rate of the reaction. The screen accepts electrons from the electropositive system and transfers these to the water to a greater rate than would be observed if the electron transfer was only occurring directly from the electropositive system to the water.

The enhanced reactor preferably contains a heat exchange coil through which water is recirculated to condense the steam within the reactor and thus remove the heat produced during the exothermic reaction. Raschig rings may also be used in the volume above the reaction area to condense this steam back into the reaction itself.

In another preferred form, the invention provides a two part process for generating hydrogen and/or energy, the first part being a primary reaction system including the sub-steps of selecting an electronegative half cell reaction producing hydrogen; selecting a first electropositive half cell reaction having a sufficient potential to drive said electronegative half cell reaction; selecting a second electropositive half cell reaction; said first and second electropositive half cell reactions selected in combination with said electronegative half cell reaction to produce an increase in hydrogen and/or energy production from water; and combining said half cell reactions; and the second part including the introduction of steam produced as a by-product of the first step at elevated temperature and a positive pressure into an enhanced reactor, wherein a portion of the energy added to the reactor system by the addition of the steam is used by reaction systems in the reactor to increase the number of dissociated H₂O ions at or near a reactive or catalytic surface. All Eₒ values herein are relative to a hydrogen reference.

In the present specification and claims, the word “comprising” and its derivatives including “comprises” and “comprise” include each of the stated integers but does not exclude the inclusion of one or more further integers.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

1. An enhanced energy production system having the step of introducing steam at elevated temperature and a positive pressure into an enhanced reactor, wherein a portion of the energy added to the reactor system by the addition of the steam is used by reaction systems in the reactor to increase the number of dissociated H₂O molecules at or near a reactive or catalytic surface.

2. An enhanced energy production system according to claim 1 wherein the steam introduced to the system is produced as a by-product of a method for generating hydrogen and/or energy from a chemical reaction including the steps of: selecting an electronegative half cell reaction producing hydrogen; selecting a first electropositive half cell reaction having a sufficient potential to drive said electronegative half cell reaction; selecting a second electropositive half cell reaction; said first and second electropositive half cell reactions selected in combination with said electronegative half cell reaction to produce an increase in hydrogen and/or energy production from water; and combining said half cell reactions.

3. An enhanced energy production system according to claim 1 further including a reaction system of one or more half cell reactions.

4. An enhanced energy production system according to claim 3 wherein the reaction system or half cell reactions require or are assisted by the provision of a reactive or catalytic surface.

5. An enhanced energy production system according to claim 3 wherein the reaction system includes on or more electropositive half cell reactions involving the oxidation of species selected from Group I or Group II metals, binary hydrides, ternary hydrides, amphoteric elements, electropositive elements in groups one and two of the periodic table and chelated transition elements, oxyacids of phosphorus and oxyacids of sulfur.

6. An enhanced energy production system according to claim 3, wherein the reaction system includes on or more electropositive half cell reactions involving a metal organic complex capable of changing configuration to release one or more electrons in a realisation of an increased co-ordination number.

7. An enhanced energy production system according to claim 3, wherein the reaction system includes the formation of a further semiconductive material or molecule.

8. An enhanced energy production system according to claim 7, wherein the semiconductive material or molecule is a composite material or molecule.

9. An enhanced energy production system according to claim 1, further including an associated heat exchange system that can be used to transfer heat from an exothermic chemical reaction in the cell or control the rate of exothermic chemical reaction(s).

10. An enhanced energy production system including a two part process for generating hydrogen and/or energy, the first part being a primary reaction system including the sub-steps of selecting an electronegative half cell reaction producing hydrogen; selecting a first electropositive half cell reaction having a sufficient potential to drive said electronegative half cell reaction; selecting a second electropositive half cell reaction; said first and second electropositive half cell reactions selected in combination with said electronegative half cell reaction to produce an increase in hydrogen and/or energy production from water; and combining said half cell reactions; and the second part including the introduction of steam produced as a by-product of the first step at elevated temperature and a positive pressure into an enhanced reactor, wherein a portion of the energy added to the reactor system by the addition of the steam is used by reaction systems in the reactor to increase the number of dissociated H₂O molecules at or near a reactive or catalytic surface.
